(19) United States
(12) Patent Application Publication
(10) Pub. No.: US 2010/0241509 A1
(43) Pub. Date: Sep. 23, 2010

(54) ADVERTISEMENT INFORMATION DELIVERY / DISPLAY METHOD, ADVERTISEMENT INFORMATION DELIVERY / DISPLAY SYSTEM, AND COMPUTER PROGRAM

(75) Inventors: Kazufumi Adachi, Tokyo (JP); Kazuhiro Miyamoto, Tokyo (JP); Kazuya Shiina, Tokyo (JP); Hiroshi Suzuki, Tokyo (JP); Shigenori Suzuki, Tokyo (JP)

Correspondence Address: NIXON & VANDERHYE, PC, 901 NORTH GLEBE ROAD, 11TH FLOOR, ARLINGTON, VA, 22203, US

(73) Assignee: PIONEER SOLUTIONS CORPORATION, Tokyo (JP)

(21) Appl. No.: 12/601,376

(22) PCT Filed: May 25, 2007
(86) PCT No.: PCT/JP2007/060722

§ 371 Date: May 27, 2010

(51) Int. Cl. G06Q 30/00; G06Q 10/00

(52) U.S. Cl. 705/14.43

(57) ABSTRACT

An advertisement information delivery/display method in an advertisement information delivery/display system which is included in a network and which comprises: a server system which can deliver advertisement information; and a terminal apparatus comprising a displaying device which can display the delivered advertisement information, said advertisement information delivery display method is provided with, in the server system, a first delivering process of delivering a plurality of advertisement information through the network to the terminal apparatus; a second delivering process of delivering a plurality of display schedules for defining display aspects of the plurality of advertisement information through the network to the terminal apparatus; in the terminal apparatus, a reproduction information obtaining process of obtaining reproduction information for specifying one display schedule to be selected of the delivered plurality of display schedules; a display schedule selecting process of selecting the one display schedule from the delivered plurality of display schedules on the basis of the obtained reproduction information; and a display controlling process of controlling the displaying device to display at least one portion of the delivered plurality of display schedules in accordance with the selected display schedule.

### TECHNICAL FIELD

The present invention relates to an advertisement information delivery/display method, an advertisement information delivery/display system, and a computer program which can be applied in a case where advertisement information is delivered and displayed on terminal apparatuses placed in a plurality of locations or in similar cases.

### BACKGROUND ART

In this type of technical field, there has been suggested a system which collectively delivers a plurality of programs (e.g. refer to a patent document 1). According to an information delivery/display system disclosed in the patent document 1 (hereinafter referred to as a “conventional technology”), it is possible to collectively deliver the plurality of programs by delivering the plurality of programs as one presentation pack through a data delivery server to an information display apparatus. Moreover, at this time, the presentation pack is delivered as at least one package, so that even if there is a transmission error, it is only necessary to transmit the package having the transmission error, and it is possible to reduce a delivery time.
Patent Document 1: Japanese Patent Application Laid Open No. 2005-198204

### DISCLOSURE OF INVENTION

### Subject to be Solved by the Invention

In such a system, a plurality of terminal apparatuses may be placed in a wide range. On the other hand, advertisements have regional characteristics in many cases. Therefore, in each of the plurality of terminal apparatuses, a program to be delivered is not necessarily completely consistent with the others. In this case, the data delivery server needs to individually deliver a plurality of presentation packs which are different from each other, in order to respond to each of the plurality of terminal apparatuses (or information display apparatuses in the conventional technology). Therefore, a human, time or processing load required for the delivery of advertisement information may significantly increases, thereby increasing cost. Moreover, it is also rare that the programs included in the presentation pack to be delivered are completely different in each terminal apparatus, and in many cases, the programs are repeated among the presentation packs. Therefore, the capacity of the data delivery server is pressed not least according to the number of presentation packs. In other words, in the conventional technology, apart from a case where the programs to be delivered to the plurality of terminal apparatuses are completely consistent with each other, the increase in delivery cost and efficient use of the server is remarkably blocked, which is technically problematic.

In view of the aforementioned problems, it is therefore an object of the present invention to provide an advertisement information delivery/display method, an advertisement information delivery/display system, and a computer program, which can deliver and display advertisement information to terminal apparatuses, efficiently and effectively.

### Means for Solving the Subject

### <Advertisement Information Delivery/Display Method>

The above object of the present invention can be achieved by an advertisement information delivery/display method in an advertisement information delivery/display system which is included in a network and which is provided with: a server system which can deliver advertisement information; and a terminal apparatus provided with a displaying device which can display the delivered advertisement information, the advertisement information delivery/display method provided with: in the server system, a first delivering process of delivering a plurality of advertisement information through the network to the terminal apparatus; a second delivering process of delivering a plurality of display schedules for defining display aspects of the plurality of advertisement information through the network to the terminal apparatus; in the terminal apparatus, a reproduction information obtaining process of obtaining reproduction information for specifying one display schedule to be selected of the delivered plurality of display schedules; a display schedule selecting process of selecting the one display schedule from the delivered plurality of display schedules on the basis of the obtained reproduction information; and a display controlling process of controlling the displaying device to display at least one portion of the delivered plurality of display schedules in accordance with the selected display schedule.

The “network” of the present invention conceptually includes wide-range communication networks including the Internet or the like as a preferred form, which can be connected through various communication networks, which are communication networks such as LAN (Local Area Network), WAN (Wide Area Network), phone lines through or without through the LAN and WAN, ADSL (Asymmetry Digital Subscriber Line), or fiber-optic lines. The network of the present invention includes a server system which can adopt the aspect of one or a plurality of computer systems or the like, such as a personal computer and a work station apparatus, and it is constructed to deliver the advertisement information.

Here, the “advertisement information” of the present invention conceptually includes information preferably accompanied by video images, about advertisement as a concept which can include information about products of various companies, such as a maker, product information at departments and floors, various service information, various event information, newly-arrived information or the like, which can be used for the watching by many and unspecific viewers, at various locations which can adopt various forms in accordance with the characteristics of clients targeted by a business owner who expands into business by using the advertisement information delivery/display system, cooperate structure, and other various circumstances, such as various stores like in railway stations, downtowns, department stores, super markets or the like, various medical institutions like hospitals, various learning service facilities like cram schools, driver's schools or the like, public facilities, event halls, companies, and offices.

The structure of the advertisement information in the present invention as the concept can adopt various types of forms; however, as a preferred form, the advertisement information may include a template file for defining a display area and material data including various video data, such as moving picture data and still picture data, to be displayed in the display area defined by the template file. Moreover, in this case, as a preferred form, one advertisement information may be established including control information such as a presentation file which associates the template file with the material data.

On the other hand, in the advertisement information delivery/display system, the terminal apparatus each of which includes the computer system as a preferred form and which is provided with the displaying device which can adopt the forms of various display apparatuses such as a plasma display apparatus equipped with a PDP (Plasma Display Panel), a liquid crystal display apparatus, or a CRT (Cathode Ray Tube), are set at the aforementioned various locations at which it is desired to watch the advertisement information by the viewers.

According to the advertisement information delivery/display method of the present invention, the plurality of advertisement information is delivered by the first delivering process to the terminal apparatus. Moreover, the plurality of display schedules are delivered by the second delivering process to the terminal apparatus, wherein the plurality of display schedules are different from each other and define the display aspects as the concept which can include the necessity or unnecessity of display, the frequency of display, the order of display, a display time point, a display period and the like, about each of the delivered plurality of advertisement information.

The first and second delivery processes may be performed continuously or discontinuously in terms of time, as mutually different delivery processes. Alternatively the first and second delivery processes may be performed as one delivery process of delivering one delivery data file (which can adopt, for example, the aforementioned presentation pack or the like) in which the plurality of advertisement information and the corresponding plurality of display schedules are established in advance for the delivery of the advertisement information, as a preferred form. Incidentally, the “delivery” performed in the server system can be treated equally to direct or indirect obtainment by download or the like through the network from the server systemₛ with the operation subject placed on the terminal apparatus.

On the terminal apparatus, in response to the delivery of the plurality of advertisement information and display schedules, the reproduction information for specifying one display schedule to be selected of the delivered plurality of display schedules is obtained by the reproduction information obtaining process. In the display schedule selecting process, one display schedule is selected on the basis of the obtained reproduction information. The displaying device is controlled by the display controlling process such that the advertisement information is displayed in the display aspect defined by the display schedule. In the advertisement information delivery/display system, the advertisement information is watched at each location in this manner.

Here, in particular, the location at which the terminal apparatus is placed can adopt various aspects in accordance with the usage form or the like of the advertisement information delivery/display system as described above, so that it covers a wide range in which the regional characteristics are mutually different to the extent that it cannot be ignored in practice according to circumstances. In other words, the terminal apparatus is placed at each of the wide-ranging plurality of locations. At this time, considering that the advertisement information to be watched by the viewers can have at least the regional characteristics, if the plurality of advertisement information is displayed in the same display schedule on each of the plurality of terminal apparatuses, the obtained advertisement effect can be easily different at each location as a necessity.

For example, even if the advertisement information about products or services which are developed or sold only in a particular area or the advertisement information about products or services or the like which are predicted in advance to have high advertisement effects only in the particular area is displayed in another area other than the particular area, it is hard to desire the advertisement effects to the extent that can be regarded as being equivalent to the advertisement effects obtained in the particular area. At this time, if there is a client such as an advertiser who tries to run various advertisements by paying the aforementioned business owner for advertisement fees to use the advertisement information delivery/display system and by having the business owner watch the advertisement information about its own product and its own service or the like, there can be a request to reduce the advertisement fees, instead of not displaying the advertisement information in the other area.

Alternatively, in the condition that the advertisement information to be displayed may be basically the same among the locations at which the terminal apparatuses are placed, it can be also considered a case where there is a request to add the mutually different advertisement information as the advertisement information to be newly displayed, at each location or at each of the plurality of location groups which are in units of the certain or uncertain number of locations or which are obtained by classifying the location in accordance with a preset standard. There can be such a request from the viewpoint of the advertiser or from the viewpoint of the business owner or the clients of the business owner (e.g. medical institutions such as hospitals, service institutions such as driving schools) who tries to improve the viewer ratings of the advertisement information delivery/display system. In any cases, the terminal apparatuses which constitute the advertisement information delivery/display system are placed at the plurality of locations, so that the optimum display schedule (which, as described above, conceptually includes whether or not each of the plurality of advertisement information is to be used for the display) easily varies at each location or location group.

For the aforementioned problems, if such a method is adopted that selects the advertisement information at each location or location group and that individually generates and delivers the display schedule suitable for the selected advertisement information as the load on the server system side (e.g. delivers it as the aforementioned delivery data file or the like), it may increase a human, time, or processing load required for the delivery of the advertisement information on the server system side, thereby increasing the delivery cost associated with the delivery of the advertisement information. Moreover, if the delivery data file as the aforementioned concept is prepared on each terminal apparatus (or at each location or each location group), the advertisement information can overlap not least among the delivery data files, so that the capacity of the server system is possibly wastefully pressed.

Here, according to the advertisement information delivery/display method of the present invention, the display aspect of the advertisement information (i.e. display schedule) including the display order of the advertisement information to be displayed and the selection of the advertisement information to be selected or the like is determined as the load on the terminal apparatus side by the display schedule selecting process performed on the terminal apparatus side. Therefore, on the server system side, there is no need to select the advertisement information to be delivered for each terminal apparatus, each location, each location group, each area, or each terminal apparatus and to individually deliver it to each terminal apparatus, each location, each location group, each area, or each terminal apparatus. In the same manner, there is no need to generate the display schedule for each terminal apparatus, each location, each location group, each area, or each terminal apparatus and to individually deliver it to each terminal apparatus, each location, each location group, each area, or each terminal apparatus. In other words, in the first and second delivering processes in the server system, it is possible to collectively deliver all the advertisement information that are possibly to be delivered and all the display schedules that are possibly to be selected, to each of the terminal apparatuses provided for the advertisement information delivery/display system. Therefore, it is possible to reduce the various loads on the server system side and to limit or control the increase in the delivery cost of the advertisement information. Moreover, it is also possible to reduce the capacity of the server system required for the delivery of the advertisement information, as soon as possible.

Moreover, in the display schedule selecting process performed on the terminal apparatus side, it is only necessary to select one display schedule on the basis of the reproduction information obtained by the reproduction information obtaining process from among the plurality of display schedules delivered by the second delivering process, so that the load on the terminal apparatus side hardly increases to the extent that there are failures such as blocking the display of the delivered advertisement information, and it is possible to easily optimize the display aspect of the advertisement information on each terminal apparatus, at each location, at each location group, in each area, or on a particular terminal apparatus. In other words, according to the advertisement information delivery/display method of the present invention, it is possible to deliver and display the advertisement information on the terminal apparatus, efficiently and effectively.

In one aspect of the advertisement information delivery/display method of the present invention, the terminal apparatus includes a computer system, the advertisement information delivery/display method is further provided with a third delivering process of delivering a computer program which makes the computer system perform the reproduction information obtaining process and the display schedule selecting process, in the server system, the reproduction information obtaining process obtains the reproduction information in accordance with the delivered computer program, and the display schedule selecting process selects the display schedule in accordance with the delivered computer program.

According to this aspect, by the third delivering process in the server system, the computer program is delivered to the terminal apparatus in synchronization with or with a certain or uncertain period out of synchronization with the delivery of the advertisement information or the display schedule. The computer program is an application program which enables the computer system on the terminal apparatus to perform the reproduction information obtaining process and the display schedule selecting process. On the terminal apparatus, the reproduction information obtaining process and the display schedule selecting process are performed in accordance with the application program.

Therefore, according to this aspect, the physical, mechanical, or electric various function modules for performing the reproduction information obtaining process and the display schedule selecting process are not necessarily mounted on the terminal apparatus main body, and the degree of freedom associated with the terminal apparatus relatively improves. Moreover, if this type of function module is mounted on the terminal apparatus, the operation of the function module is fixed, and the load that cannot be ignored in practice can be accompanied when various post-processing is performed, such as function addition, function modification, or performance improvement. Therefore, if the operation of the terminal apparatus is controlled in accordance with the computer program delivered in this manner, it is possible to easily improve the operation performance of the terminal apparatus associated with the reproduction information obtaining process and the display schedule selecting process by updating the computer program to be delivered before the delivery, with respect to the plurality of terminal apparatuses and theoretically all the terminal apparatuses included in the advertisement information delivery/display system.

Incidentally, as described above, considering that the reproduction information obtaining process and the display schedule selecting process on the terminal apparatus are performed by the computer program delivered in the third delivering process, the third delivering process is performed in synchronization with at least one of the aforementioned first and second delivering processes, as a preferred form. Moreover, as an extreme and effective form, the first, second, and third delivering processes may be collectively performed as one delivering process. In other words, as a specific and effective example, the computer program may be delivered as one data file, with it included in the aforementioned delivery data file or the like including at least the advertisement information and the display schedule.

In another aspect of the advertisement information delivery/display method of the present invention, the advertisement information delivery/display method is further provided with a fourth delivering process of delivering a reproduction information file which associates the reproduction information with identification information for identifying the terminal apparatus through the network to the terminal apparatus, and the reproduction information obtaining process includes an identification information obtaining process of obtaining the identification information and obtains one reproduction information corresponding to the obtained identification information from the delivered reproduction information file.

According to this aspect, the reproduction information file which associates the identification information with the reproduction information to be obtained on each terminal apparatus is delivered by the fourth delivering process in the server system. On the other hand, the reproduction information obtaining process performed on the terminal apparatus includes the identification information obtaining process for obtaining the identification information.

Here, the “identification information” of the present invention conceptually includes information which is unique to the terminal apparatus and which can specify the location or location group at which at least the terminal apparatus is placed. For example, it may be an ID number and ID symbol or the like assigned such that there are no overlaps, to each of the terminal apparatuses included in the advertisement information delivery/display system. Alternatively, for example, it may be information overlapping among the terminal apparatuses placed at the locations close to each other to the extent that disadvantages due to at least the same display schedule of the advertisement information do not appear at least in practice.

The aspect of the identification information obtaining process for obtaining the identification information is not Limited at all as long as the identification information can be obtained. For example, it may be obtained by requesting the server system to transmit information corresponding to the identification information (including the identification information itself) through the network. Alternatively, it may have an aspect of referring to information given in accordance with the predetermined standard associated with the physical, mechanical, or electric structure of the terminal apparatus in the advertisement information delivery/display system, from a proper storage place. Alternatively, the identification information may be delivered, as occasion demands, such that it is included in or accompanied by the delivery-target information in at least one of the first, second, third, and fourth delivering processes.

According to this aspect, it is possible to simply obtain the reproduction information by selecting one reproduction information from the reproduction information file. Incidentally, at this time, the fourth delivering process may be performed in synchronization with at least one of the first and second delivering processes, as in the aforementioned third delivering process. As a more effective form, the fourth delivering process may be performed as one delivering process including the first and second delivering processes, with it included in the aforementioned delivery data file or the like.

In another aspect of the advertisement information delivery/display method of the present invention, the advertisement information delivery/display method is further provided with a reproduction information transmitting process of transmitting the reproduction information through the network to the terminal apparatus in the server system, and the reproduction information obtaining process obtains the transmitted reproduction information.

According to this aspect, the reproduction information is transmitted to the terminal apparatus from the server system by the reproduction information transmitting process. Therefore, the reproduction information obtaining process is simply realized.

Incidentally, in this aspect, the server system may be provided with a memory device for storing a reproduction information file which associates the reproduction information with identification information for identifying the terminal apparatus, the advertisement information delivery/display method may be further provided with a reproduction information selecting process of selecting one reproduction information on the basis of the identification information from the stored reproduction information file, and the reproduction information transmitting process may transmit the selected one reproduction information.

In this case, the reproduction information file having the same concept as described above as a form of the advertisement information delivery/display method of the present invention is stored in the server system. The reproduction information is selected on the basis of the identification information on each terminal apparatus in the reproduction information selecting process, and it is transmitted to each terminal by the reproduction information transmitting process. Therefore, the processing load in the transmission of the reproduction information is reduced.

In an aspect in which the reproduction information selecting process is provided, the reproduction information obtaining process may include an identification information obtaining process of obtaining the identification information and an identification information transmitting process of transmitting the obtained identification information through the network to the server system, and the reproduction information selecting process may select the one reproduction information on the basis of the transmitted identification information,

In this case, the identification information obtained by the identification information obtaining process as one portion of the reproduction information obtaining process, which has the same concept as described above, is further transmitted to the server system by the identification information transmitting process as one portion of the reproduction information obtaining process. Therefore, a process of specifying the identification information is not necessary in the reproduction information selecting process on the server system side. In other words, as the reproduction information selecting process, it is only necessary to select one reproduction information corresponding to the identification information which is transmitted from the terminal apparatus, from the reproduction information file, and the processing load is remarkably reduced.

In one aspect of the advertisement information delivery/display method of the present invention in which the identification information is referred to, the identification information includes ID information assigned to the terminal apparatus in advance.

According to this aspect, various ID information such as an ID number and ID symbol is assigned to the terminal apparatus as the identification information, so that there is a lower possibility that the wrong reproduction information is obtained when the reproduction information is obtained on the basis of the identification information.

In another aspect of the advertisement information delivery/display method of the present invention, the advertisement information delivery/display method is further provided with: a fifth delivering process of delivering the reproduction information or predetermined standard information which defines a standard of the display schedule through the network to the terminal apparatus; and a judging process of judging whether or not to use the standard information on the basis of a state of the network on the terminal apparatus, in the server system, and the display schedule selecting process further determines the display schedule corresponding to the standard information as the display schedule to be used for the display of the advertisement information if it is judged that the standard information is to be used.

According to this aspect, the standard information is delivered to the terminal apparatus by the fifth delivering process performed in synchronization with or with a certain or uncertain period out of synchronization with at least one of the first and second delivering processes. On the terminal apparatus, it is judged whether or not to use the standard information in the judging process. At this time, whether or not to use the standard information is judged in the circumstances that the reproduction information is hardly obtained theoretically, practically, or realistically due to network failures, delivery errors, or troubles of the server system.

Here, the standard information is not only information that is the standard of the reproduction information used for the selection of the display schedule (i.e. the standard reproduction information) but may be information corresponding to the display schedule itself which is the standard. In the display schedule selecting process, if it is judged that the standard information is to be used, one display schedule is selected on the basis of the reference information, or the standard information is selected as the display schedule without through the process of selecting one display schedule from among the delivered plurality of display schedules, depending on the form of the standard information, and it is eventually determined as the display schedule to be used for the display of the advertisement information.

Therefore, according to this aspect, even if there is a situation that it is hard to obtain the reproduction information due to various physical, mechanical, or electric factors in the advertisement information delivery/display system, i.e. the network failure or the like as a more specific example, it is possible to determine at least the display schedule, regardless of whether or not the display schedule is optimized on each terminal apparatus. In other words, it is possible to avoid the occurrence of so-called broadcasting failure or broadcasting accident in which the advertisement information cannot be correctly displayed without any display schedule selected because the reproduction information is not obtained. In view of the characteristics of the advertisement information, regardless of whether or not the display schedule is optimized on each terminal apparatus, as long as it is used for the display through the displaying device, a certain degree of appeal effect to the viewer is obtained as compared to a case where no advertisement information is displayed. Thus, the practical effect obtained from the delivery of the standard information can be extremely high.

### <Advertisement Information Delivery/Display System>

The above object of the present invention can be achieved by an advertisement information delivery/display system which is included in a network and which is provided with: a server system which can deliver advertisement information; and a terminal apparatus provided with a displaying device which can display the delivered advertisement information, the server system is provided with: a first delivering device for delivering a plurality of advertisement information through the network to the terminal apparatus; and a second delivering device for delivering a plurality of display schedules for defining display aspects of the plurality of advertisement information through the network to the terminal apparatus, the terminal apparatus is provided with: a reproduction information obtaining device for obtaining reproduction information for specifying one display schedule to be selected of the delivered plurality of display schedules; a display schedule selecting device for selecting the one display schedule from the delivered plurality of display schedules on the basis of the obtained reproduction information; and a display controlling device for controlling the displaying device to display at least one portion of the delivered plurality of display schedules in accordance with the selected display schedule.

According to the advertisement information delivery/display system of the present invention, it is possible to obtain the same effects as those of the advertisement information delivery/display method of the present invention described above, by the operation of each device which realizes each process in the advertisement information delivery/display method of the present invention described above. Incidentally, in response to the various aspects of the advertisement information delivery/display method described above, the advertisement information delivery/display system of the present invention can also adopt various aspects.

### <Computer Program>

The above object of the present invention can be achieved by a computer program which makes a computer system perform the reproduction information obtaining process and the display schedule selecting process according to any of claims 1 to 8 (including their various aspects).

According to the computer program of the present invention, the reproduction information obtaining process and the display schedule selecting process in the advertisement information delivery/display method of the present invention described above can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects in the reproduction information obtaining process and the display schedule selecting process of the present invention described above, the computer program of the present invention can also adopt various aspects.

Moreover, the above object of the present invention can be achieved by a computer program product in a computer-readable medium for tangibly embodying a program of instructions executable by a computer, computer program making the computer perform the reproduction information obtaining process and the display schedule selecting process of the present invention (including their various aspects).

According to the computer program product of the present invention, the reproduction information obtaining process and the display schedule selecting process in the advertisement information delivery/display method of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the Like, into the computer, or by downloading the computer program product, which may be a carrier wave, into the computer via a communication device. More specifically, the computer program product may include computer readable codes to cause the computer (or may comprise computer readable instructions for causing the computer) to perform the reproduction information obtaining process and the display schedule selecting process in the advertisement information delivery/display method of the present invention.

As explained above, the advertisement information delivery/display method of the present invention is provided with the first delivering process, the second delivering process, the reproduction information obtaining process, the display schedule selecting process, and the display controlling process, so that it enables the terminal apparatus to display the advertisement information, efficiently and effectively.

As explained above, the advertisement information delivery/display system of the present invention is provided with the first delivering device, the second delivering device, the reproduction information obtaining device, the display schedule selecting device, and the display controlling device, so that it enables the terminal apparatus to display the advertisement information, efficiently and effectively.

As explained above, the computer program of the present invention makes the computer system perform the reproduction information obtaining process and the display schedule selecting process of the present invention, so that it enables the terminal apparatus to display the advertisement information, efficiently and effectively.

The operation and other advantages of the present invention will become more apparent from the examples explained below,

### BRIEF DESCRIPTION OF DRAWINGS

FIG. 1 is a schematic structure diagram conceptually showing the structure of an advertisement information delivery/display system in a first embodiment of the present invention.

FIG. 2 is a schematic structure diagram conceptually showing the structure of a presentation pack delivered in the advertisement information delivery/display system in FIG. 1.

FIG. 3 is a block diagram showing a data delivery server in the advertisement information delivery/display system in FIG. 1.

FIG. 4 is a block diagram showing a reproduction information management server in the advertisement information delivery/display system in FIG. 1,

FIG. 5 is a schematic diagram showing a reproduction information file in the reproduction information management server in FIG. 4.

FIG. 6 is a block diagram showing a display terminal in the advertisement information delivery/display system in FIG. 1.

FIG. 7 is a timing chart in the advertisement information delivery/display system in FIG. 1.

FIG. 8 is a flowchart showing a schedule selecting process in the advertisement information delivery/display system in FIG. 1.

### DESCRIPTION OF REFERENCE CODES

10 advertisement information delivery/display system
12 delivery company
20 presentation pack
23 automatic presentation script
28 schedule generation function module
100 data delivery server
200 reproduction information management server
300A, 300B, 300C display terminal
341 schedule management processing device
342 reproduction processing device

### BEST MODE FOR CARRYING OUT THE INVENTION

Hereinafter, the best mode for carrying out the present invention will be described in each embodiment with reference to the drawings, as occasion demands.

### 1: First Embodiment

### 1-1: Structure of Embodiment

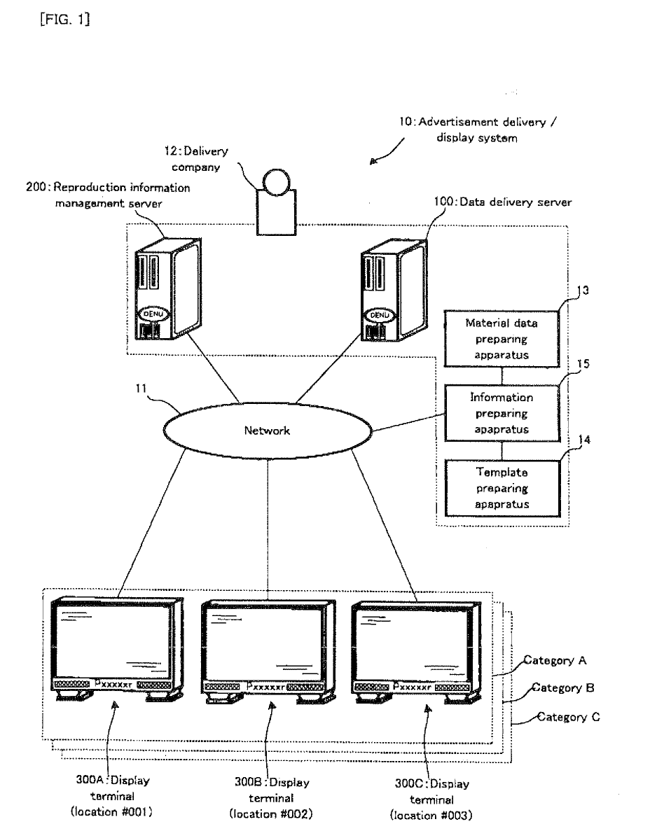

Hereinafter, with reference to FIG. 1 to FIG. 6, an explanation will be given on the structure of an advertisement information delivery/display system 10 in a first embodiment of the present invention.

### 1-1-1: Basic Structure of Advertisement Information Delivery I Display System

Firstly, with reference to FIG, 1, the basic structure of the advertisement information delivery/display system 10 will be conceptually explained. FIG. 1 is a schematic structure diagram conceptually showing the structure of the advertisement information delivery/display system 10 in the first embodiment of the present invention.

In FIG. 1, the advertisement information delivery display system 10 is included in a network 11 established as a wide-range communication network, such as the Internet, and it is provided with a material data preparing apparatus 13, an information management server 200, and display terminals 300A, 300B, and 300C. The advertisement information delivery/display system 10 is one example of the “advertisement information delivery/display system” of the present invention.

The advertisement information delivery/display system 10 is managed by a delivery company 12 and is used for an advertisement information delivery service developed by a company not illustrated. This company looks for clients as advertisers in each category which can be appropriately determined. The company displays advertisements about products or merchandises owned by each client or services or events developed by the client or the like, on the display terminal placed in each location, as advertisement information including at least vide information. The company collects advertisement fees from the clients as the consideration, or usage charges from the clients corresponding to the respective locations at which the terminal apparatuses are placed.

For example, in a category of a medical field or the like, for example, waiting rooms in hospitals and various medical institutions are the locations for displaying the advertisement information. In a category of driving schools, for example, waiting rooms at driving schools are the locations. Alternatively, if railway stations are a category, for example, the railroad yards, especially, around ticket gates and free passages or the like which are busy can be the locations. As described above, considering that the characteristics of viewers for the advertisement information at the locations (age groups, sex, preference, or interest or the like of viewers) can be different not least in the respective various categories which can be set relatively arbitrarily, the clients can be naturally different in the respective categories.

Incidentally, in FIG. 1, categories A to C are shown as one example, and the display terminals 300A, 300B, and 300C belong to the category A are placed at locations #001, #002, and #003, respectively. Moreover, the display terminals 300A, 300B, and 300C shown in FIG. 1 are merely one portion of the display terminals that belong to the category A, and actually, more display terminals (e.g. several hundred or several thousand display terminals) are placed at locations which are different from each other in a wide range to the extent that the regional characteristics can be sufficiently different. Incidentally, in the explanation below, unless otherwise noted, a term of “display terminals 300” is used as occasion demands, as a general term of the display terminals provided for at least one category,

Incidentally, a relation among the delivery company 12, a business owner, and the client is not necessarily unique, and for example, the delivery company 12 may be substantially the business owner. Alternatively, the client may be the business owner. Moreover, the display terminals that belong to one category of the advertisement information delivery/display system 10 may have the same owner or different owners.

### 1-1-2: Structure of Presentation Pack

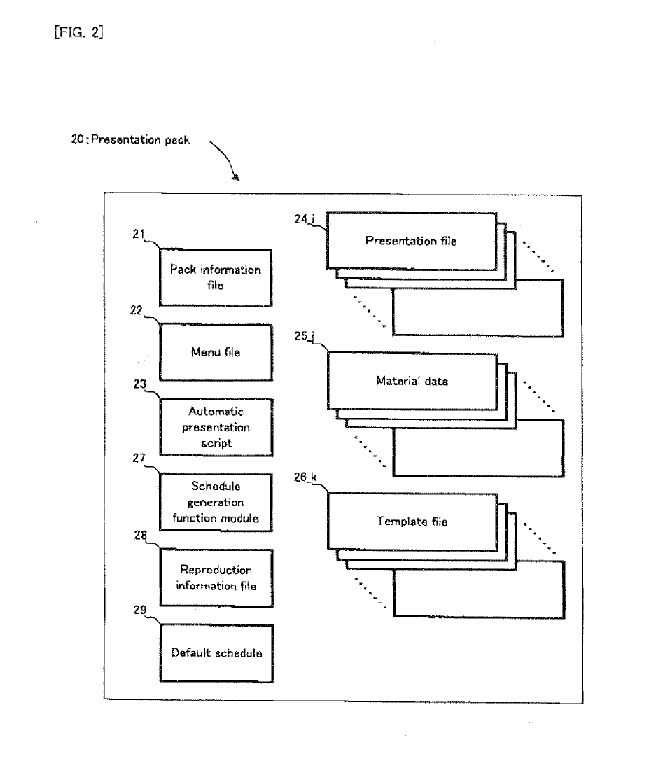

In the advertisement information delivery/display system 10, the advertisement information is delivered to each display terminal as a presentation pack (hereinafter referred to as a “PR pack”, as occasion demands) 20 which is the largest file treated by the advertisement information delivery/display system 10. Now, with reference to FIG. 2, the structure of the PR pack 20 will be explained. FIG. 2 is a schematic structure diagram conceptually showing the structure of the PR pack 20.

In FIG. 2, the presentation pack 20 is provided with a pack information file 21, a menu file 22, an automatic presentation script (hereinafter referred to as an “automatic PR script”, as occasion demands) 23, a plurality of presentation files 24_{—}i (i=1, 2, . . . , L (wherein L is a natural number)), a plurality of material data 25_{—}j (j=1, 2, . . . , M (wherein M is a natural number)), a plurality of template files 26_{—}k (k=1, 2, . . . , N (wherein N is a natural number)), a schedule generation function module 27, a reproduction information file 28, and a default schedule 29.

The pack information file 21, the menu file 22, the automatic PR script 23, the presentation files 24_{—}i and the template files 26_{—}k are normally control information files for defining information necessary for the display of the advertisement information provided with a plurality of material data (contents). The material data (contents) 25_{—}j is actual display data displayed by the operation of the control information files.

The material data 25_{—}j is content data used in the template files 26_{—}k. The material data 25_{—}j includes a moving picture file such as a MPEG (Moving Picture Experts Groups) format and animation GIF (Graphic Interchange Format); a still picture file such as a JPEG (Joint Photographic Coding Experts Group) format, a PNG (Portable Network Graphics) format, GIF (Graphic Interchange Format), and TIFF (Tagged Image Format); an audio file such as a MIDI (Musical Instruments Digital Interface) format, a MP3 (MPEG Audio Layer-3) format, and a WMA (Windows(R) Media Audio); an audio moving picture file including audio and moving picture information in a Flash format; a text file; and the like, as occasion demands.

In the template files 26_{—}k, display position information indicating a display position of at least one display area (window) for displaying each material data, a display size of the display area, a reproduction player used to reproduce the material data displayed in the display area (a relation between the display area and the reproduction player) and the like are defined. The definition of the template files 26_{—}k can easily change a layout on the display screen of the display terminal 300. In other words, it is possible to prepare different advertisement information by preparing a plurality of template files having different definitions to change the display layout by the template files to be used, or by changing the material data displayed in each display area established on the display screen by using the same template file.

In the presentation files 24_{—}i, relation information among the file name of one template file 26_{—}k, the aforementioned at least one display area (display area name) defined in the one template file, and at least one material data 25_{—}j (file name) is defined. In other words, one presentation file corresponds to one advertisement information, and each of the presentation files 24_{—}i is used for the file management of the material data 25_{—}j and the template files 26_{—}k.

In the menu file 22, information for defining a menu screen including a selection button for the viewer of the advertisement information to select one of the plurality of advertisement information (corresponding to the plurality of presentation files 24_{—}i) and relation information between the selection buttons (selection button names) and the file names of the presentation files are defined.

In the automatic PR script 23, the display schedules of the plurality of advertisement information defined by the presentation files 24_{—}i are defined for a display schedule A, a display schedule B, . . . , and a display schedule Z. Here, the display schedule indicates information for defining a display start time point and a display end time point of the advertisement information expressed by each presentation file. In other words, one display start time point and one display end time point in one display schedule correspond to one presentation file name. As a necessity, the presentation file in which the display start time point and the display end time point are not defined is the advertisement information which is not used for the display under the display schedule. For example, in one display schedule defined in the automatic PR script 23, the display start time point and the display end time point in each presentation file may be defined such that all the presentation files 24_{—}i are displayed repeatedly in order every 5 minutes from 10 am to 8 pm.

In the pack information file 21, the file names of the menu file 22 and the automatic PR script 23 are defined, and the pack information file 21 is used for the file management of them. The presentation files 24_{—}i are managed by the menu file 22 and the automatic PR script 23.

The schedule generation function module 27 is a computer program which can be executed on the terminal apparatus 300, and it is one example of the “computer program” of the present invention. The schedule generation function module 27 is adapted to start when the PR pack 20 is delivered to each display terminal and to set the display schedule of the advertisement information on each display terminal. Incidentally, the detailed operation of the schedule generation function module 28 will be described later.

The reproduction information file 28 is a file for defining a correspondence between each of the plurality of display terminals which belongs to one category of the advertisement information delivery/display system 10 (e.g. the plurality of display terminals including the display terminals 300A, 300B, and 300C in the category A) and one display schedule to be selected from the plurality of display schedules defined by the automatic PR script in each display terminal.

The default schedule 29 is a display schedule used in emergency, and it is one example of the “standard information” of the present invention.

The PR pack 20 in the embodiment having the aforementioned structure basically has a common structure among the plurality of display terminals which belongs to one category of the advertisement information delivery/display system 10 (e.g. the plurality of display terminals including the display terminals 300A, 300B, and 300C in the category A).

### 1-1-3: Upload of PR Pack 20

Next, back in FIG. 1, an explanation will be given on the structures of the material data preparing apparatus 13, a template preparing apparatus 14, and an information preparing apparatus 15 for uploading the PR pack 20 in a data delivery server 100 in the advertisement information delivery/display system 10, as well as one portion of the operation thereof.

The material data preparing apparatus 13 is a computer system such as a personal computer for a creator who belongs to the delivery company 12 or who receives a commission from the delivery company 12 to prepare the material data 25_{—}j, and it has a material data preparation function of preparing the material data having the format of the aforementioned moving picture file, still picture file, text file, audio moving picture file, or the like.

The template preparing apparatus 14 is a computer system such as a personal computer for the creator who belongs to the delivery company 12 or who receives a commission from the delivery company 12 to prepare the template files 26_{—}k, and it has a template preparation function of preparing the aforementioned template files.

The information preparing apparatus 15 is a computer system such as a personal computer for a producer who belongs to the delivery company 12 or who receives a commission from the delivery company 12 to prepare the advertisement information. The information preparing apparatus 15 prepares all the files included in the presentation pack 20 shown in FIG. 2 by using each template file prepared by the template preparing apparatus 14 and various material data prepared by the material data preparing apparatus 13. The presentation pack 20 prepared in this manner is transmitted to the data delivery server 100 through the network 11 from the information preparing apparatus 15.

The information preparing apparatus 15 is provided with a presentation preparation function, a schedule /menu preparation function, a pack preparation function, and a data upload function.

The presentation preparation function is a function for the producer to prepare the plurality of presentation files 24_{—}i corresponding to the plurality of advertisement information by using the template files 26_{—}k prepared by the template preparing apparatus 14 and the various material data 25_{—}j prepared by the material data preparing apparatus 13. Specifically, as described above, the producer defines the file name of one template file in each one presentation file and defines the relation between the aforementioned at least one display area (display area name) defined in the one template file and at least one material data 25_{—}j (file name). Moreover, the presentation preparation function has a function of reproducing the material data by using the template file defined in the presentation file and of displaying the advertisement information in order to confirm the presentation file prepared by the producer.

The schedule/menu preparation function is a function of preparing the automatic PR script 23 and the menu file 22 described above by determining the display schedule of each presentation file prepared by the presentation preparation function, on the basis of display priority information indicating the priority of the display order of each presentation file specified by the producer.

The pack preparation function is a function of preparing the newest presentation pack 20 when the menu file 22, the automatic PR script 23, the present files 24_{—}i, or the pack information file 21 is prepared or changed.

The data upload function is a function of uploading the presentation pack 20 prepared by the pack preparation function by transmitting it to the data delivery server 100 through the network 11. In this case, in the data upload function, a plurality of packages are prepared such that at least one file is included in one package, from the plurality of files included in the presentation pack 20. The prepared plurality of packages are encrypted by a package unit before package identification information is added, and they are transmitted to the data delivery server 100. The package identification information includes information indicating the name of the presentation pack to which a self-package belongs, the content of the files included in the self-package, and the like. Incidentally, the data upload function is adapted to judge whether the targeted presentation pack 20 is new or updated when the package is prepared and to prepare and transmit the package including only the updated files in the case of the updated presentation pack. The packing is to reduce the amount of data in one data communication. If the data amount is small, the presentation pack 20 itself may be encrypted and transmitted to the data delivery server 100.

### 1-1-4: Structure of Data Delivery Server 100

The data delivery server 100 is a computer system adapted to monitor and control the display terminals 300, and it is one example of the “server system” of the present invention. The data delivery server 100 has a presentation pack management function, a terminal management function, and a log collection function.

The presentation pack management function allows the package received from the information preparing apparatus 15 to be stored, and it judges whether the received package is a package that constitutes the new presentation pack 20 or a package that includes only the updated files in the already-stored presentation pack 20, from the package identification information. In the case of the package including only the updated files, the presentation pack management function decodes the stored package and the package received from the information preparing apparatus 15, changes only the updated portion (the files of the package received from the information preparing apparatus 15) in the stored presentation pack 20, packs them, encrypts them, and stores them.

The terminal management function requests the display terminals 300 to transmit information indicating various states in the display terminals 300 (hereinafter referred to “management information” as occasion demands), such as load information about the CPUs of the display terminals 300 and temperature of display devices. Moreover, the terminal management function is adapted to transmit a request for the download of the presentation pack 20 or the package to the display terminals 300, to transmit an instruction to select one presentation pack from the plurality of presentation packs already stored on the display terminals 300, or to transmit an instruction to change a polling interval, if access is provided by polling from the display terminals 300.

The log collection function is a function of collecting and storing monitor information transmitted from the display terminals 300. The various data stored by the log collection function is used for reference by the delivery company 12.

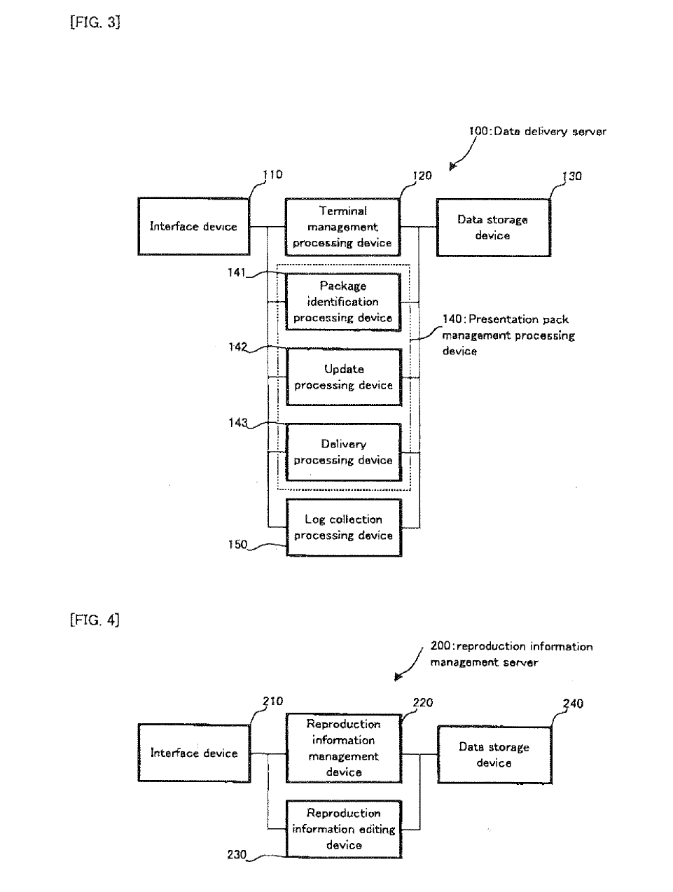

Now, with reference to FIG, 3, the detailed structure of the data delivery server 100 will be explained. FIG. 3 is a block diagram showing the data delivery server 100.

In FIG, 3, the data delivery server 100 is provided with an interface device 110, a terminal management processing device 120, a data storage device 130, a presentation pack management processing device 140, and a log collection processing device 150.

The interface device 110 is a function block having an interface function for performing mutual communication with each display terminal and the information preparing apparatus 15 through the network 11.

The terminal management processing device 120 is a function block to realize the aforementioned terminal management function and is adapted to request the display terminals 300 to transmit the monitor information, such as the load information about the CPUs of the display terminals 300 and temperature of display parts of the display terminals 300, to the display terminals 300 if access is provided by polling from the display terminals 300. Moreover, the terminal management processing device 120 is adapted to transmit a request for the download of the presentation pack 20 or the package to the display terminals 300, to transmit an instruction to select one presentation pack from the plurality of presentation packs already stored on the display terminals 300, or to transmit an instruction to change a polling interval, if access is provided by polling from the display terminals 300.

The data storage device 130 is a relatively large-capacity memory apparatus having a rewritable memory area and is adapted to store the presentation pack 20 or the package transmitted from the information preparing apparatus 15. Moreover, the data storage device 130 is adapted to store the delivery history (or update history and transmission history) of the presentation pack 20. The update history is the name of the updated file in the package, the update time and date of the file, and the name of the presentation pack to which the package belongs. The transmission history is the name of the presentation pack delivered to the display terminals 300 and its transmission time and date. Moreover, the data storage device 130 can also store the monitor information collected by the log collection processing device 150,

The presentation pack management processing device 140 is a function block to realize the aforementioned presentation pack management function, and it is provided with a package identification processing device 141, an update processing device 142, and a delivery processing device 143.

The package identification processing device 141 is adapted to judge whether the package received from the information preparing apparatus 15 is one package that constitutes the new PR pack 20 or package that includes only the updated files in the already-stored presentation pack 20, from the package identification information,

The update processing device 142 updates the files in the package stored in the data storage device 130 to the files of the received package if the received package is the package including only the updated files. Moreover, the update processing device 142 is adapted to prepare the update history and to store the prepared update history into the data storage device 130 when updating the files in the package.

The delivery processing device 143 is adapted to deliver the package which belongs to the requested PR pack 20 (which may be the PR pack 20 itself as described above) in response to the request for the delivery of the PR pack 20 from the display terminals 300. The delivery processing device 143 judges whether the presentation pack in which the delivery is requested corresponds to the presentation pack to be newly delivered or the already-delivered presentation pack. In the case of the already-delivered presentation pack, the delivery processing device 143 prepares and transmits the package including only the updated files. Moreover, the delivery processing device 143 is adapted to prepare the transmission history when transmitting the package and store the prepared transmission history into the data storage device 130.

The log collection processing device 150 is a function block to realize the aforementioned log collection function and is adapted to collect the monitor information transmitted from the display terminals 300 and to store the collected monitor information into the data storage device 130.

### 1-1-5: Structure of Reproduction Information Management Server 200

The reproduction information management server 200 is a computer system adapted to function as one example of the “server system” of the present invention, together with the data delivery server 100. In other words, in the embodiment, the “server system” of the present invention is provided with a plurality of computer systems. Now, with reference to FIG. 4, the detailed structure of the reproduction information management server 200 will be explained. FIG. 4 is a block diagram showing the reproduction information management server 200,

In FIG. 4, the reproduction information management server 200 is provided with an interface device 210, a reproduction information management device 220, a reproduction information editing device 230, and a data storage device 240.

The interface device 210 is a function block having an interface function for performing mutual communication with each display terminal and the information preparing apparatus 15 through the network 11.

The reproduction information management device 220 is a function block adapted to manage reproduction information about each of the plurality of display terminals 300 provided for the advertisement information delivery/display system 10 in each category described above and to transmit the reproduction information corresponding to each display terminal in response to the request from each display terminal. Here, the reproduction information is one of control information set in the delivery company 12, and it is information for selecting one display schedule from the aforementioned automatic PR script 23 included in the PR pack 20 delivered to the display terminals 300.

In the reproduction information management device 220, the reproduction information is managed as a reproduction information file set in each category. Here, the reproduction information file is basically the same as the reproduction information file 28 included in the PR pack 20; however, the reproduction information file managed in the reproduction information management device 220 (hereinafter expressed as the reproduction information file 28 without distinction) is relatively more reliable information than the reproduction information file 28 included in the PR pack 20, which always includes the newest reproduction information, due to appropriate editing by the reproduction information editing device 230 as described later. In other words, the reproduction information file 28 included in the PR pack 20 is basically changed only in the delivery timing of the PR pack 20. Thus, for example, if delivery frequency is set to a relatively long span, such as once a month, then, there is a possibility that the reproduction information file 28 does not include the reproduction information corresponding to the display terminal 300 which is newly set after the delivery of the PR pack 20.

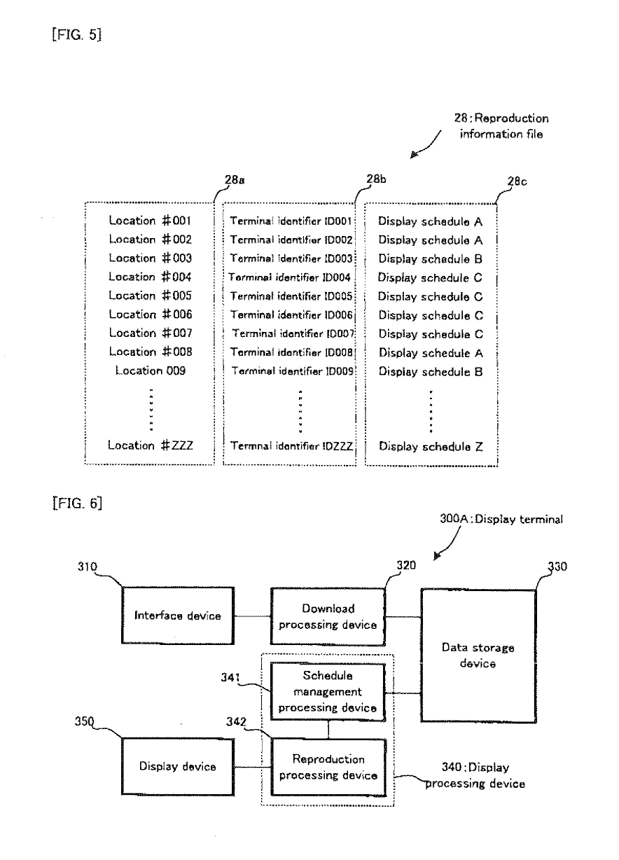

Now, with reference to FIG. 5, the structure of the reproduction information file 28 will be explained. FIG, 5 is a schematic diagram showing the reproduction information file 28.

In FIG, 5, the reproduction information file 28 is provided with a location information group 28a, a terminal identifier group 28b, and a display schedule group 28c, and it has such a structure that pieces of unit information that constitute the respective information groups are associated with each other among the information groups.

The location information group 28a is an information group in which information about the location of each display terminal is described. Incidentally, location #001 is the location of the display terminal 300A as described above. In the same manner, location #002 and location #003 correspond to the locations of the display terminals 300B and 300C, respectively.

The terminal identifier group 28b is an information group in which a terminal identifier which is identification information unique to each display terminal is described in association with the location information group 28a. In other words, the terminal identifiers of the display terminals 300A, 300B, and 300C are set to ID 001, ID 002, and ID 003, respectively.

The display schedule group 28c is an information group in which one display schedule is described in association with location information and the terminal identifier from among the plurality of display schedules defined by the automatic PR script 23 (in the embodiment, there are a schedule A to a schedule Z, as described above). In other words, the reproduction information file 28 in the state shown in FIG. 8 specifies that the display schedule A is to be selected in the display terminal 300A which is placed at the location #001 and to which the terminal identifier ID001 is assigned.

Back in FIG. 4, the reproduction information editing device 230 is a function block having a reproduction information editing function for the creator who belongs to the delivery company 12 or who receives a commission from the delivery company 12 to prepare and edit the reproduction information and the reproduction information file 28. By virtue of such a function of the reproduction information editing device 230, a relation between the reproduction information and the display terminals 300a is changed as occasion demands. For example, the reproduction information file 28 is appropriately updated if the display terminal is newly placed in one category, or on the contrary, if the display terminal is removed, or if the display schedule to be selected in the existing display terminal is to be changed (e.g. if at least one portion of the presentation file to be reproduced in a particular location is changed, or if the reproduction order of the presentation files is changed, or the like) or in similar cases.

Incidentally, the generation and editing of the reproduction information or the reproduction information file by the delivery company 12 or the like may be performed on an external apparatus which is different from the reproduction information management server 200 (e.g. the information preparing apparatus 15 or the like). In this case, the generated or edited reproduction information or reproduction information file may be uploaded on the reproduction information management server 200 through the network 11, as occasion demands. The reproduction information editing device 230 may be a function body which updates the reproduction information or the reproduction information file.

The data storage device 240 is a relatively large-capacity memory apparatus having a rewritable memory area, and it is adapted to store the reproduction information file 28 to be appropriately edited by the reproduction information editing device 230.

### 1-1-6: Structure of Display Terminal 300

The display terminal 300 is an apparatus for displaying the advertisement information prepared by the information preparing apparatus 15, and it is one example of the “terminal apparatus” of the present invention. The display terminal 300 has a schedule management function and a reproduction display function, and it decodes and stores the package or the PR pack 20 downloaded from the data delivery server 100.

The schedule management function is a function of managing the advertisement information on the basis of one selected display schedule of the display schedules defined by the automatic PR script 23 in the PR pack 20, and it outputs a reproduction instruction to start the reproduction of the advertisement information and a stop instruction to stop the reproduction of the advertisement information, to the reproduction display function. The reproduction instruction is outputted at the display start time point described in the relevant display schedule or if particular advertisement information is selected by the viewer of the advertisement information pressing one selection button on the menu screen. The reproduction instruction includes the file name of the presentation file corresponding to the advertisement information to be reproduced. The stop instruction is outputted at the display end time point specified by the relevant display schedule during the display of the advertisement information or if the advertisement information which is different from the currently reproduced advertisement information is selected by the viewer of the advertisement information through the menu screen or the like, or in similar cases.

Moreover, the schedule management function also has a function of selecting and changing one PR pack 20 as occasion demands from among the plurality of PR packs 20 already stored, on the basis of a control instruction transmitted through the data delivery server 100. For example, this function is used in order to select the PR pack 20 for this month for sure (in order not to select the PR pack 20 for next month by mistake) if the PR pack 20 for next month is delivered in advance under the condition that the PR pack 20 is delivered on a monthly basis.

The reproduction display function is a function of displaying the advertisement information on the basis of the presentation file included in the reproduction instruction. The reproduction display function reproduces the material data corresponding to the display area of the template file defined in the presentation file by using a reproduction player for each area, and it displays a program. Incidentally, if the template file is not defined in the presentation file, the reproduction display function displays the advertisement information by using a default template file stored in advance.

Now, with reference to FIG. 6, the detailed structure of the display terminal 300 will be explained, FIG. 6 is a block diagram showing the display terminal 300.

In FIG. 6, the display terminal 300 is provided with an interface device 310; a download processing device 320; a data storage device 330; a schedule management processing device 341; a display processing device 340 having a schedule management processing device 341 and a reproduction processing device 342; and a display device 350,

The interface device 310 is a function block for performing mutual communication with the data delivery server 100 through the network 11.

The download processing device 320 is a function block adapted to download the PR pack 20 or package in response to a download request for the PR pack 20 or package from the data delivery server 100 and to decode the downloaded PR pack 20 or package, decompress it, and store it into the data storage device 330.

The data storage device 330 is a relatively large-capacity memory apparatus having a rewritable memory area adapted to store the downloaded PR pack 20 or package.

The schedule management processing device 341 is a processing device which realizes the aforementioned schedule management function and a function block for managing the display schedule of the advertisement information on the basis of one display schedule selected from the automatic PR script 23 in the PR pack 20. Moreover, the schedule management processing device 341 is adapted to change the display schedule as occasion demands to reproduce the presentation file corresponding to the selected button when any one of the plurality of selection buttons displayed on the display device 350 by the menu file 22 is selected by the viewer of the advertisement information.

Here, in particular, the schedule management processing device 341 is a function block in which function addition is performed by the aforementioned schedule generation function module 27 included in the PR pack 20, and it is adapted to select one schedule by the function addition from among the plurality of display schedules defined in the automatic PR script 23. The operation associated with the schedule selection will be described later.

The reproduction processing device 342 is a function block adapted to reproduce the material data corresponding to the display area of the template file defined in the presentation file by using the reproduction player of each area and to display the advertisement information on the display device 350 provided with a plasma display apparatus or the like.

### 1-2: Operation in Embodiment

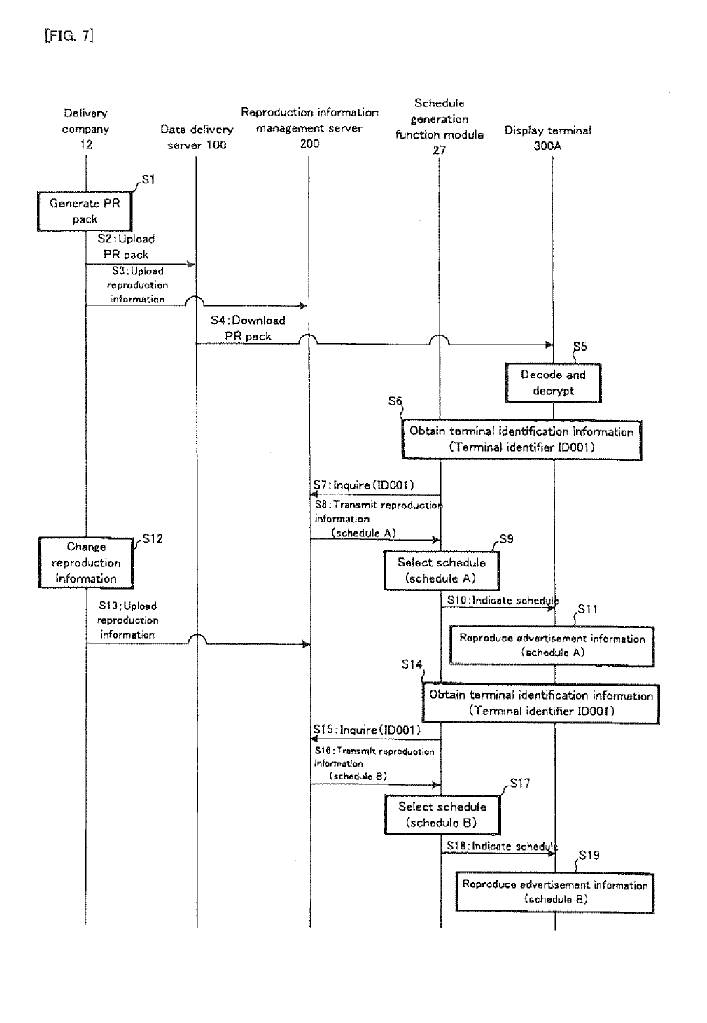

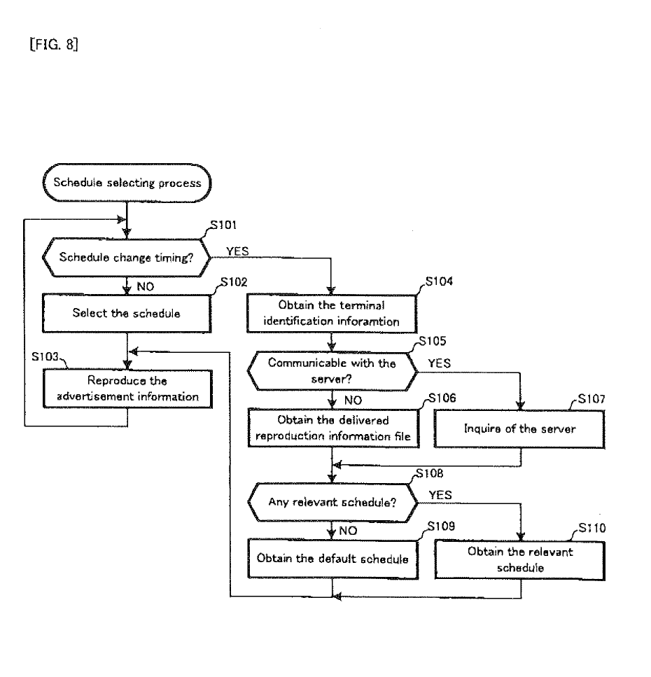

In the advertisement information delivery/display system 10 having the aforementioned structure, the advertisement information is extremely efficiently and effectively displayed (i.e. the presentation file is reproduced) with the display schedule which varies at each location. Here, the operation in the embodiment will be explained with reference to FIG. 7. FIG. 7 is a timing chart showing such a flow that the advertisement information is delivered and watched by the viewer in each location in the advertisement information delivery/display system 10.

In FIG. 7, it is assumed that the vertical axis adopts the time and that time passes downward. On the other hand, the horizontal axis shows the delivery company 12 (mainly, the information preparing apparatus 15), the data delivery server 100, the reproduction information management server 200, the schedule generation function module 27, and the display terminal 300A, in order from the left as the operation subject. Incidentally, here, the display terminal 300A is shown as a representative; however, the basic operations of the display terminals 300 are equal to each other among the plurality of display terminals.

In FIG. 7, in the delivery company 12, the PR pack 20 is generated by the aforementioned operations of the material data preparing apparatus 13, the template preparing apparatus 14, the information preparing apparatus 15, and the like (step S1). The generated PR pack 20 is uploaded on the data delivery server 100 (step S2).

On the other hand, in the delivery company 12, the reproduction information file 28 is updated by the operation of generating or editing the reproduction information on the reproduction information editing device 230 of the reproduction information management server 200 or the external apparatus or the like (step 53). Incidentally, considering that the PR pack 20 includes the reproduction information file 28, the reproduction information file 28 may be uploaded before the step S1 is performed. However, the reproduction information file 28 included in the PR pack 20 is not necessarily the newest, so that the reproduction information file 28 may be uploaded such that the reproduction information file 28 generated at the delivery step of the PR pack 20 is included in the PR pack 20.

If the PR pack 20 is uploaded on the data delivery server 100, the uploaded PR pack 20 is delivered to all the display terminals that belong to the relevant category (i.e. including the display terminal 300A in this case) (step S4). In other words, the PR pack 20 is downloaded from the data delivery server 100, with the display terminal 300 side as the operation subject.

Incidentally, as described above, the PR pack 20 includes the automatic PR script 23, and at this time point, one example of each of the “first delivering process” and the “second delivering process” of the present invention is realized. Moreover, the PR pack 20 includes the schedule generation function module 27, the reproduction information file 28, and the default schedule 29. By virtue of the delivery of the PR pack 20, one example of each of the “third delivery processing”, the “fourth delivery processing”, and the “fifth delivery processing” of the present invention is realized.

If the PR pack 20 is delivered (downloaded), the encrypted and compressed PR pack 20 is decoded and decompressed on the display terminal 300A (step S5). After the decoding and decompression process, the schedule generation function module 27 included in the PR pack 20 is started. If the schedule generation function module 27 is started, the schedule management processing device 341 is controlled in operation by the schedule generation function module 27, and firstly, it obtains terminal identification information (i.e. the aforementioned terminal identifier) (step S6). In other words, one example of the “identification information obtaining process” of the present invention is realized_{—} In the embodiment, the terminal identification information is delivered with the PR pack 20 as a terminal identification information file.

If the schedule management processing device 341 obtains the terminal identifier (here, the terminal identifier ID 001) from the delivered terminal identification information file, the schedule management processing device 341 inquires the reproduction information of the reproduction information delivery server 200 (step S7). In other words, it realizes one example of the “identification information transmitting process” of the present invention. The reproduction information delivery server 200 selectively obtains one relevant reproduction information with reference to the reproduction information file stored in the data storage device 240 on the basis of the terminal identifier ID 001 transmitted from the display terminal 300A, and it replies to the schedule management processing device 341 (i.e. transmits the information (data) corresponding to the relevant reproduction information which fits the display terminal 300A). In other words, one example of each of the “reproduction information selecting process” and the “reproduction information transmitting process” of the present invention is realized. As shown in FIG. 5, the display schedule corresponding to the terminal identifier ID 001 is the display schedule A, and the reproduction information indicating that the display schedule A is to be selected is replied to the schedule management processing device 341. At this stage, one example of the “reproduction information obtaining process” of the present invention is realized,

If the display schedule to be selected is obtained as the reproduction information, the schedule management processing device 341 selects the display schedule A from the automatic PR script 23 on the basis of the obtained reproduction information (step S9). In other words, it performs one example of the “display schedule selecting process” of the present invention. If the display schedule A is selected, the schedule management processing device 341 passes the selected display schedule A to the reproduction processing device 342. As a result, the display device 350 of the terminal apparatus 300A is controlled such that the presentation file in which it is specified to be reproduced by the display schedule A is displayed in accordance with the display start time point and the display end time point described in the display schedule A. In other words, one example of the “display controlling process” of the present invention is realized. As a result, the advertisement information according to the schedule A is displayed on the display terminal 300A (step S11).

Here, it is assumed that it is desired to change the presentation file (i.e. to change the display schedule) to be reproduced on the display terminal 300A or another display terminal after the delivery of the PR pack 20 due to the request from the client as the advertiser or due to the circumstances of the business owner or the like. In that case, the reproduction information is edited in the same manner as the process in the step S3 in the delivery company 12 (step S12), and it is uploaded on the reproduction information management server 200 (step S13),

On the other hand, the schedule generation function module 27 controls the operation of the schedule management processing device 341 such that the reproduction information is inquired with a certain period (i.e. the same process as in the step S7), with respect to the reproduction information management server 200. In other words, the terminal identifier is obtained (step S14), the reproduction information is inquired (step S15), and the relevant reproduction information is obtained (step S16).

At this time, if the display schedule corresponding to the display terminal 300A is changed to the display schedule B due to the change in the reproduction information in the step S12, the reproduction information indicating that the display schedule B is to be selected is replied to the schedule management processing device 341 in the process associated with the step S16.

The schedule management processing device 341 selects the schedule B in the same processes as in the steps S9 and S10 (step S17) and passes it to the reproduction processing device 342 (step S18). The reproduction processing device 342 controls the display device 350 such that the advertisement information according to the schedule B is displayed, as in the process associated with the step S11 (step S19).

As described above, in the advertisement information delivery/display system 10 in the embodiment, even if the advertisement information to be displayed on the display terminal 300 is changed after the delivery of the advertisement information, it is possible to respond to the change, quickly, efficiently, and effectively, only by editing the reproduction information file, regardless of the degree of the change (e.g. even in the change only on one display terminal, or even in the change in the plurality of display terminals placed at the plurality of locations).

Therefore, when there is the change in the advertisement information to be displayed on the display terminal, it is unnecessary to regenerate and redeliver the PR pack 20 at each time in a form individually corresponding to each relevant display terminal, and for example, the data delivery server 100 can collectively deliver the advertisement information to at least all the display terminals in each category. Thus, it is possible to display the optimum advertisement information on each of the display terminals 300 while limiting or controlling an increase in cost required for the delivery of the PR pack 20. In other words, it is possible to deliver and display the advertisement information on the display terminal, efficiently and effectively

Now, a detailed explanation will be given on the schedule selecting process realized by the schedule generation function module 27 on the display terminal 300. FIG. 8 is a flowchart showing the schedule selecting process.

In FIG. 8, the schedule management processing device 341 judges whether or not it is the change timing of the display schedule (step S101). Here, the changing timing of the display schedule is not necessarily accompanied by the change in the display schedule selected at the current time point, and it conceptually includes timing in which it is determined to inquire the reproduction information to the reproduction information management server 200, with or without the necessity. Therefore, the changing timing of the display schedule may be a time point at which the display terminal 300 starts (e.g. timing which comes at least once a day if the start and the end are repeated every day) or may be a case where the advertisement information corresponding to the current time point is not described in the display schedule selected at the current time point. Alternatively, it may be arbitrary timing appropriately set from the side of the delivery company 12 or the business owner.

If it is not the change timing of the schedule (the step S101: No), the schedule management processing device 341 selects the display schedule on the basis of the effective reproduction information at the current time point (step S102) and passes the selected display schedule to the reproduction processing device 342 and enables it to display the advertisement information (step S103) After the process in the step S103 is performed, the operational flow returns to the step S101.

If it is the change timing of the display schedule (the step S101: YES), the schedule management processing device 341 obtains the terminal identification information (i.e. the terminal identifier) with reference to the terminal identification information file as described above (step S104). When obtaining the terminal identification information, the schedule management processing device 341 judges whether or not communication is established with the reproduction information management server 200 (step S105). Here, if there is no trouble about the communication in each of the reproduction information management server 200 and the display terminals 300 and the communication is established among them (the step S105: YES), the schedule management processing device 341 obtains the reproduction information from the reproduction information management server 200 through the inquire of the reproduction information management server 200 (step S107), and the operational flow moves to a step 5108.

On the other hand, if the communication is not established with the reproduction information management server 200 for the reason that there is some trouble in at least one portion of the reproduction information management server 200 and the display terminals 300 (step 5105: NO), the schedule management processing device 341 obtains the reproduction information file 28 delivered with it included in the PR pack 20 (step S106), and the operational flow moves to the step S108.

In the process in the step S108, it is judged whether or not there is the display schedule to be selected. In other words, one example of the “judging process” of the present invention is performed. Here, if it goes through the process in the step S107, the newest reproduction information is transmitted at this time point from the reproduction information management server 200, so that it is easy to select one display schedule from the automatic PR script 23. The judgment branch in the step S107 is “yes”, and the operational flow moves to a step S110 to obtain the relevant display schedule.

On the other hand, if it goes through the process in the step S106, the reproduction information file 28 obtained in the process in the step S106 is a file when the PR pack 20 is delivered, and if a proper time elapses from the delivery, the newly added display terminal 300 is not possibly described in the reproduction information file 28. In other words, the reproduction information corresponding to the terminal identifier is uncertain, and the schedule management processing device 341 cannot select the display schedule, and the judgment branch in the step S108 is “NO”.

If there is no relevant display schedule, the schedule management processing device 341 obtains the default schedule 29 delivered with it included in the PR pack 20 (step S109). The default schedule 29 is a common display schedule in all the display terminals in each category, and it is established as a highly versatile schedule, such as a display schedule in which it is defined to display the presentation file in order with a certain period. If some display schedule is selected in the step S109 or the step S110, the schedule management processing device 341 moves the process to the step S103. The schedule selecting process is performed in this manner in detail.

Here, according to the schedule selecting process, as long as a communication line is established with the reproduction information management server 200, the newest reproduction information is obtained from the reproduction information management server 200. Even if the communication line is not established, it is tried to obtain the reproduction information with reference to the reproduction information file 28 included in the PR pack 20. Moreover, even if the reproduction information is not described in the delivered reproduction information file 28, i,e, even in case of emergency, at least the default schedule is eventually selected. Therefore, the schedule management processing device 341 can be used to select the display schedule and to display the advertisement information apart from the effectiveness in any cases, and the appeal effect of the advertisement information in the advertisement information delivery/display system 10 is guaranteed to the minimum degree at least. In other words, the aforementioned peculiar effect of the present invention that the advertisement information is delivered and displayed efficiently and effectively is provided in a more useful manner in practice.

Moreover, according to the advertisement information delivery/display system 10 in the embodiment, the schedule generation function module 28 as the computer program is delivered with it included in the PR pack 20. Therefore, as compared to a case where it is tried to obtain the equivalent function to the schedule generation function module 27 by physically or mechanically implementing the function module which can realize the equivalent function to the schedule generation function module 27 with respect to the display terminals 300, it is easy to add, expand, or update the function and it is apparently useful in practice. Moreover, in view of such a structure that the computer program delivered in the above manner enables the schedule management processing device 341 to perform the peculiar operation of the present invention, the physical, mechanical, and electric structure of the display terminals 300 may be so simple that the advertisement information is displayed in accordance with the selected schedule, and it can provide extremely high convenience in the point that it does not cause the addition of new hardware.

Incidentally, in the embodiment, the data delivery server 100 and the reproduction information management server 200 are provided as one example of the “server system” of the present invention, and they may be integrated as a unified computer system. In other words, the function associated with the reproduction information management server 200 (or the data delivery server 100) may be further provided for the data delivery server 100 (or the reproduction information management server 200). Moreover, the server system may be further segmentized.

Moreover, in the embodiment, the terminal identifier exemplified as trigger information (key information) when the reproduction information is requested (or inquired) of the reproduction information management server 200; however, this type of trigger information is not limited to the terminal identifier. For example, it may be the physical, mechanical, or electric characteristics of the display device 350 or the like in each of the display terminals. For example, display resolution, the size of the display area, or the like may be adopted as the characteristics.

In this case, although there is weak correlation with the regional characteristic of the advertisement information, the advertisement information can be displayed to the viewer in the optimum state in accordance with the resolution and the size of the display area, so that it is extremely useful from the viewpoint of optimizing the appeal effect of the advertisement information. Moreover, this type of trigger information can be used with the aforementioned terminal identifier. In that case, it is also possible to display the advertisement information, more effectively.

### 2: Second Embodiment

In the first embodiment, the reproduction information is set as information indicating that one display schedule to be selected is specified from among the plurality of display schedules defined in the automatic PR script 23. Considering that the display schedule is determined on the display terminal 300 side with the start of the schedule generation function module 27, higher degree of freedom can be given as the reproduction information. Such a second embodiment will be explained below.

In the second embodiment, as the reproduction information, command information is given instead of the information for specifying the display schedule, wherein the command information is based on the characteristics of various files (e.g. the presentation files 24_{—}i, the material data 25_{—}j, or the template files 26_{—}k or the like) included in the delivered PR pack 20, such as information for specifying that “X (arbitrary) presentation files are reproduced in ascending (descending) order of the file size” or information for specifying that “the presentation file in which 00 is used as the material data (or template file)”.

If the reproduction information is obtained as the command information, the schedule management processing device 341 to which the function is added by the schedule generation function module 27 can generate the display schedule. As a result, it is easy to display the advertisement information in accordance with the display schedule which is different from the delivered display schedule in the form of the automatic PR script 23 in advance, and the appeal effect of the advertisement information realized by the advertisement information delivery/display system 10 is further improved.

The present invention is not limited to the aforementioned embodiments, but various changes may be made, if desired, without departing from the essence or spirit of the invention which can be read from the claims and the entire specification. An advertisement information delivery/display method, an advertisement information delivery/display system, and a computer program, all of which involve such changes, are also intended to be within the technical scope of the present invention.

### INDUSTRIAL APPLICABILITY

The advertisement information delivery/display method, the advertisement information delivery/display system, and the computer program of the present invention can be applied to an advertisement information delivery/display system which enables the displaying device provided for the terminal apparatus to display the advertisement information or the like. Moreover, they can be also applied to the terminal apparatus, which is constructed as various computer equipment for consumer use or for commercial use or which is constructed as equipment connectable to the various computer equipment.

1.-10. (canceled)

11. An advertisement information delivery/display method in an advertisement information delivery/display system which is included in a network and which comprises: a server system which can deliver advertisement information; and a terminal apparatus comprising a displaying device which can display the delivered advertisement information, said advertisement information delivery/display method comprising:
in the server system,
a first delivering process of delivering a plurality of advertisement information through the network to the terminal apparatus;
a second delivering process of delivering a plurality of display schedules each of which defines respective one of mutually different display aspects about the delivered plurality of advertisement information through the network to the terminal apparatus;
in the terminal apparatus,
a reproduction information obtaining process of obtaining reproduction information for specifying one display schedule to be selected of the delivered plurality of display schedules;
a display schedule selecting process of selecting the one display schedule from the delivered plurality of display schedules on the basis of the obtained reproduction information; and
a display controlling process of controlling the displaying device to display at least one portion of the delivered plurality of display schedules in accordance with the one display aspect defined by the selected one display schedule.

12. The advertisement information delivery/display method according to claim 11, wherein
the terminal apparatus includes a computer system,
said advertisement information delivery/display method further comprises a third delivering process of delivering a computer program which makes the computer system perform said reproduction information obtaining process and said display schedule selecting process, in the server system,
said reproduction information obtaining process obtains the reproduction information in accordance with the delivered computer program, and
said display schedule selecting process selects the display schedule in accordance with the delivered computer program.

13. The advertisement information delivery/display method according to claim 11, wherein
said advertisement information delivery/display method further comprises a fourth delivering process of delivering a reproduction information file which associates the reproduction information with identification information for identifying the terminal apparatus through the network to the terminal apparatus, and
said reproduction information obtaining process includes an identification information obtaining process of obtaining the identification information and obtains one reproduction information corresponding to the obtained identification information from the delivered reproduction information file.

14. The advertisement information delivery/display method according to claim 11, wherein
said advertisement information delivery/display method further comprises a reproduction information transmitting process of transmitting the reproduction information through the network to the terminal apparatus in the server system, and
said reproduction information obtaining process obtains the transmitted reproduction information.

15. The advertisement information delivery/display method according to claim 14, wherein
the server system comprises a memory device for storing a reproduction information file which associates the reproduction information with identification information for identifying the terminal apparatus,
said advertisement information delivery/display method further comprises a reproduction information selecting process of selecting one reproduction information on the basis of the identification information from the stored reproduction information file, and
said reproduction information transmitting process transmits the selected one reproduction information.

16. The advertisement information delivery/display method according to claim 15, wherein
said reproduction information obtaining process includes an identification information obtaining process of obtaining the identification information and an identification information transmitting process of transmitting the obtained identification information through the network to the server system, and
said reproduction information selecting process selects the one reproduction information on the basis of the transmitted identification information.

17. The advertisement information delivery/display method according to claim 13, wherein the identification information includes ID information assigned to the terminal apparatus in advance.

18. The advertisement information delivery/display method according to claim 11, wherein
said advertisement information delivery/display method further comprises: a fifth delivering process of delivering the reproduction information or predetermined standard information which defines a standard of the display schedule through the network to the terminal apparatus; and a judging process of judging whether or not to use the standard information on the basis of a state of the network on the terminal apparatus, in the server system, and
said display schedule selecting process further determines the display schedule corresponding to the standard information as the display schedule to be used for the display of the advertisement information if it is judged that the standard information is to be used.

19. An advertisement information delivery/display system which is included in a network and which comprises: a server system which can deliver advertisement information; and a terminal apparatus comprising a displaying device which can display the delivered advertisement information,
the server system comprises.
a first delivering device for delivering a plurality of advertisement information through the network to the terminal apparatus; and
a second delivering device for delivering a plurality of display schedules each of which defines respective one of mutually different display aspects about the delivered plurality of advertisement information through the network to the terminal apparatus,
the terminal apparatus comprises:
a reproduction information obtaining device for obtaining reproduction information for specifying one display schedule to be selected of the delivered plurality of display schedules;
a display schedule selecting device for selecting the one display schedule from the delivered plurality of display schedules on the basis of the obtained reproduction information; and
a display controlling device for controlling the displaying device to display at least one portion of the delivered plurality of display schedules in accordance with the one display aspect defined by the selected one display schedule.

20. A computer program which makes a computer system perform a reproduction information obtaining process and a display schedule selecting process in an advertisement information delivery/display method in an advertisement information delivery/display system which is included in a network and which comprises: a server system which can deliver advertisement information; and a terminal apparatus comprising a displaying device which can display the delivered advertisement information, said advertisement information delivery/display method comprising
in the server system,
a first delivering process of delivering a plurality of advertisement information through the network to the terminal apparatus;
a second delivering process of delivering a plurality of display schedules each of which defines respective one of mutually different display aspects about the delivered plurality of advertisement information through the network to the terminal apparatus;
in the terminal apparatus,
said reproduction information obtaining process of obtaining reproduction information for specifying one display schedule to be selected of the delivered plurality of display schedules;
said display schedule selecting process of selecting the one display schedule from the delivered plurality of display schedules on the basis of the obtained reproduction information; and
a display controlling process of controlling the displaying device to display at least one portion of the delivered plurality of display schedules in accordance with the one display aspect defined by the selected one display schedule.
